(19) United States
(12) Patent Application Publication
(10) Pub. No.: US 2008/0216287 A1
(43) Pub. Date: Sep. 11, 2008

(54) Hinge Boot and Method of Assembling Hinge Mechanisms

(75) Inventor: William D. Suh, Cary, NC (US)

Correspondence Address: COATS & BENNETT/SONY ERICSSON, 1400 CRESCENT GREEN, SUITE 300, CARY, NC, 27511, US

(73) Assignee: Sony Ericsson Mobile Communications AB, Lund (SE)

(21) Appl. No.: 11/684,026

(22) Filed: Mar. 9, 2007

(51) Int. Cl. E05D 7/10

(52) U.S. Cl. 16/262

(57) ABSTRACT

A hinge mechanism pivotably connects the two housings of a clamshell-type electronic device, and includes a hinge head, a hinge body, and retaining boots around the hinge head and hinge body. The hinge mechanism and the retaining boots fit tightly within openings integrally formed in a housing of the device. As a user pivots the housings between open and closed positions, the retaining boots expand to fill in any spatial gaps that might develop between the exterior surface of the hinge mechanism and the interior surfaces of the openings. This maintains the tight fit between the hinge mechanism and the housings.

### BACKGROUND

The present invention relates generally to hinge mechanisms, and more particularly to hinge mechanisms for clamshell-type electronics devices.

Manufacturers of clamshell-type electronics devices, such as flip phones, typically have two housings pivotably connected by a hinge. In general, the hinge pivotally connects a housing that includes a display to another housing that includes a keypad or other input interface. Other clamshell-type electronics devices, such as laptop and notebook computers, for example, also use these types of hinges.

Although there are many different types of hinges available, the current trend is for electronics manufacturers to use “cartridge hinges.” Cartridge hinges usually fit within one or both of the housings, and contain a cam mechanism and a spring. The spring biases the cam mechanism axially such that the cam mechanism yieldingly resists the user opening or closing the housings. Once the user overcomes this initial resistance, the spring may provide a force to urge the housings into the open or closed position.

Manufacturers are attracted to using cartridge hinges for their devices because they are small, self-contained, and inexpensive. Additionally, many different types and sizes of cartridge hinges are readily available “off-the-shelf.” This negates the need for manufacturers to customize or specially design hinges for a particular device. Despite these beneficial characteristics, however, cartridge hinges are not without their drawbacks.

Structurally, most conventional cartridge hinges for electronics devices are very small. This small size can be problematic during the manual labor phases of the assembly of the device. For example, it is difficult for humans to manipulate such small components efficiently. Further, conventional cartridge hinges require special tools to assemble the cartridge hinge, and to install the cartridge hinge during assembly of the electronic device to ensure a tight fit between the cartridge hinge and the housing of the device. Additionally, the repeated opening and closing of the device may cause wear between the exterior of the cartridge hinge and the interior of the electronic device housings that contain the cartridge hinge. This wear causes the original tight fit between the cartridge hinge and the device housing to loosen. Consequently, the resulting loose fit between the cartridge hinge and the device housing decreases the effectiveness of the cartridge hinge and degrades consumer confidence in the manufacturer's device. Parts can be replaced or repaired; however, the associated costs effectively prohibit such actions from being viable for manufacturers.

### SUMMARY

The present invention is directed to a hinge mechanism for pivotably connecting two housings of a clamshell-type electronic device. In one embodiment, a hinge mechanism comprises a hinge body that mates with an opening integrally formed in a first housing of an electronic device, and a hinge head that mates with a corresponding opening integrally formed in a second housing of the electronic device. The hinge body at least partially contains the components that function to yieldingly resist a user pivoting the first and second housings between open and closed positions. Elastic retaining boots formed as sleeves are disposed within the openings and around the exterior surfaces of the hinge body and the hinge head. The retaining boots are sized and shaped to maintain a tight fit between the hinge body and the hinge boot, and their respective openings.

The user may pivot the housings relative to one another to open and close the electronic device. Repeatedly opening and closing the device, however, may cause spatial gaps to form between the exterior surfaces of the hinge body and/or the hinge head and the interior surfaces of their respective openings. Additionally, dropping the device or temperature changes may also cause spatial gaps to form. These small spatial gaps may loosen the original tight fit between the hinge body and the hinge boot, and their respective openings. The retaining boots expand to fill in these spatial gaps, and thus, maintains a tight fit between the hinge body and the hinge head and the interior surfaces of the openings.

### BRIEF DESCRIPTION OF THE DRAWINGS

FIG. 1 illustrates an electronics device suitable for use with one embodiment of the present invention.

FIG. 2 illustrates an exploded view of one embodiment of the present invention.

FIG. 3 illustrates a hinge mechanism configured according to one embodiment of the present invention.

FIG. 4 illustrates a possible placement for a hinge mechanism within the housing according to one embodiment of the present invention.

FIG. 5 is a flow chart illustrating a method by which an electronics device might be assembled to include a hinge mechanism configured according to one embodiment of the present invention.

FIG. 6 is a flow chart illustrating another method by which an electronics device might be assembled to include a hinge mechanism configured according to one embodiment of the present invention.

FIG. 7 illustrates an exploded view of another embodiment of the present invention.

### DETAILED DESCRIPTION

Turning now to the figures, the present invention comprises a hinge mechanism that pivotably connects the two housings of a clamshell-type electronic device. In one embodiment, a pair of retaining boots formed as sleeves substantially surrounds a cartridge hinge. Together, the cartridge hinge and the retaining boots are disposed within corresponding openings such that the retaining boots are between the cartridge hinge and the interior surfaces of their respective openings. The retaining boots function to fill in spatial gaps that might develop between the cartridge hinge and the interior surfaces of the openings to maintain a tight fit between the cartridge hinge and the openings.

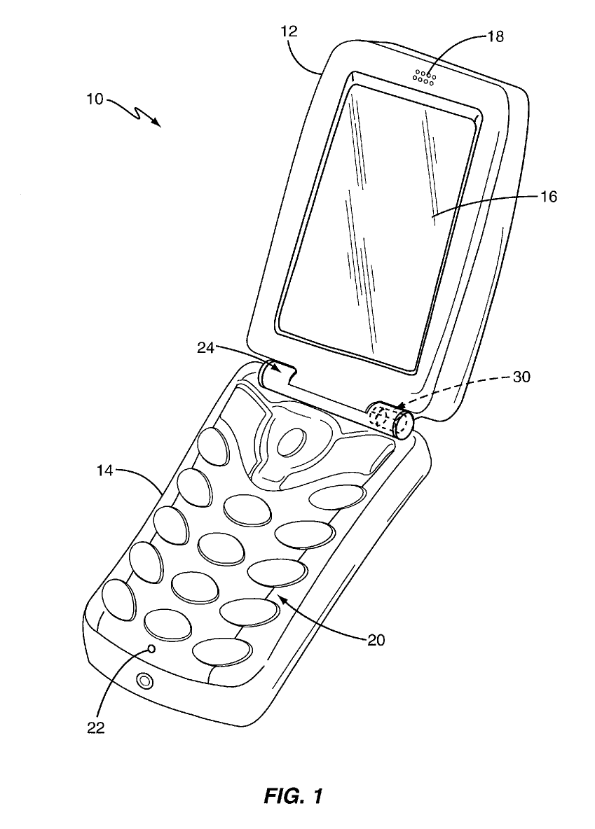

FIG. 1 illustrates a cellular telephone 10 that includes a hinge mechanism configured according to one embodiment of the present invention. While the description and the drawings describe the present invention in terms of pivotably connecting the two housings of a cellular telephone 10, it is for illustrative purposes only. One or more hinge mechanisms configured according to the present invention may pivotably connect two or more housings of any clamshell-type electronic device. Examples of suitable devices include, but are not limited to, laptop and notebook computing devices, mobile communications devices, and personal electronics devices such as Personal Digital Assistants (PDAs), calculators, and the like.

Cellular telephone 10 comprises a first housing 12 pivotably connected to a second housing 14 by an internally disposed hinge mechanism, such as cartridge hinge 30. The cartridge hinge 30 allows the first and second housings 12, 14, to pivot between the “open” and “closed” positions relative to one another. Particularly, the cartridge hinge 30 initially yieldingly resists a user opening and closing the first and second housings 12, 14. Once the user overcomes this initial force, however, the cartridge hinge 30 functions to urge the first and/or second housings 12, 14 into the open or closed positions.

The first and second housings 12, 14 include, inter alia, a display 16, a speaker 18, a user interface 20, and a microphone 22. Cellular telephone 10 also typically includes communications circuitry (not shown) within the first and/or second housings 12, 14 to allow users to communicate with remote parties via a wireless communications network (not shown). Generally, such circuitry includes one or more microprocessors, memory, and long-range and/or short-range transceivers that operate according to any known standard. Suitable standards include, but are not limited to, the Global System for Mobile Communications (GSM), TIA/EIA-136, cdmaOne, cdma2000, UMTS, Wideband CDMA, and BLUETOOTH.

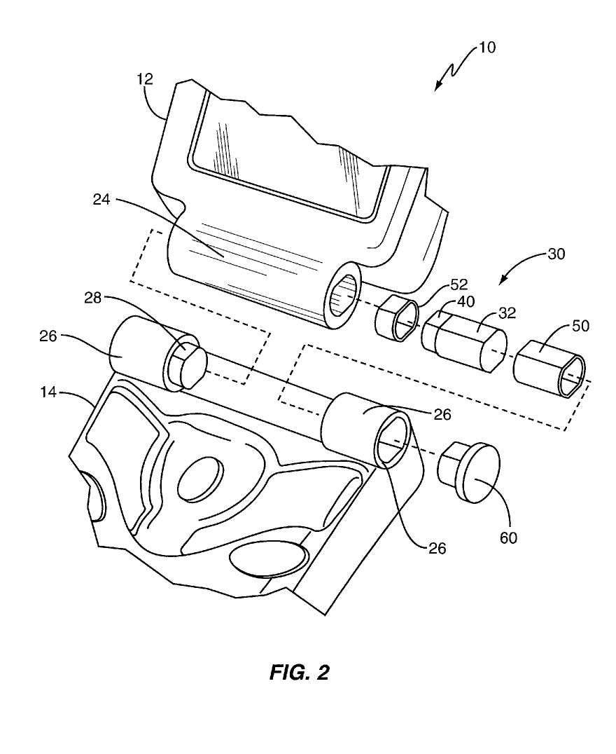

FIG. 2 is an exploded view illustrating how a cartridge hinge 30 configured according to one embodiment of the present invention might pivotably connect the first and second housings 12, 14. The first housing 12 includes an integrally formed sleeve 24, while the second housing 14 includes a pair of integrally formed opposing posts 26. The integrally formed sleeve 24 and at least one of the posts 26 each have openings or cavities. The opening in the post 26 receives a first retaining boot 50 that mates with a body 32 of the cartridge hinge 30, while the opening in the sleeve 24 receives a second retaining boot 52 that mates with a head 40 of the cartridge hinge 30. The other side of the integrally formed sleeve 24 connects to a removable bushing 28 that is inserted into the other post 26. An end cap 60 may be inserted into one or both of the posts 26 to cover any openings. Once assembled, the first and second housings 12, 14 pivot relative to each other between the open and closed positions on the cartridge hinge 30.

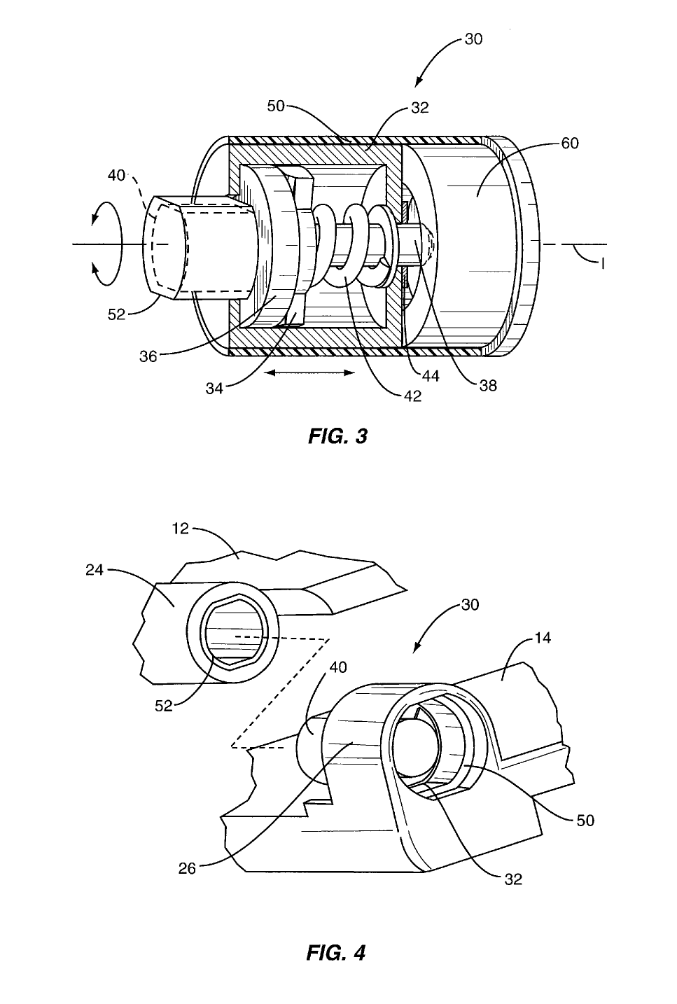

FIGS. 3 and 4 illustrate one embodiment of the cartridge hinge 30 in more detail. Those skilled in the art, however, will appreciate that this is for illustrative purposes only and that cartridge hinge 30 may be designed to have other shapes and sizes.

As seen in FIG. 3, the cartridge hinge 30 comprises a generally cylindrical housing or body 32 that encloses a cam member 36 and a cam follower 34 mounted on a floating shaft 38. The floating shaft 38 extends through a rear wall of the hinge body 32 and is retained by a “C-clip” 44. A hinge head 40 is fixedly attached to the other end of the shaft 38. A biasing mechanism, which in this embodiment comprises a spring 42, biases the cam follower 34. When the user opens and closes the housings 12, 14, the hinge head 40 and the cam 36 move together with housing 12, while cam follower 34 and hinge body 32 move together with housing 14. A first retaining boot 50 may be sized and shaped to substantially surround a portion of the hinge body 32 on cartridge hinge 30. A second retaining boot 52 may be sized and shaped to substantially surround the hinge head 40 of cartridge hinge 30. An end cap 60 may couple to one end of the cartridge hinge 30.

In operation, based on cam profile, the spring 42 biases the cam follower 34 axially outward toward cam 36, but also compresses to allow the cam follower 34 to move axially inward. The axial movement of the cam follower 34 is dictated by the profile of the cam 36. Particularly, the hinge head 40 and the cam 36 rotate when the user pivots the housing 12 between the open and closes positions. As the cam follower 36 rotates, a raised detent or cam surface formed on cam 36 pushes a corresponding cam surface formed on cam follower 34. As the spring 42 gets compressed to allow the cam follower 34 to move axially inward, they resist the user's pivoting motion. However, once the user opens a phone housing to reach a predetermined open angle, the spring 42 biases the cam follower 34 axially outward according to the cam profile. This facilitates semi automatic opening and closing of the housings 12, 14.

Because the components that facilitate the opening and closing of the housings 12, 14 are largely contained within the hinge body 32, it is important for the hinge body 32 to fit tightly inside of post 26 of housing 14 and not move after installation. Likewise, it is important for the hinge head 40 to fit tightly inside of sleeve 24 of housing 12 and not move after installation. However, the torque placed on the hinge body 32 and the hinge head 40 from the repeated opening and closing motions could cause the hinge body 32 and/or the hinge head 40 to wear on the interior surface of post 26 and/or sleeve 24. This wear could also deform the interior of post 26 and/or sleeve 24, and create spatial gaps between the hinge body 32 and post 26, and hinge head 40 and sleeve 24. These spatial gaps would allow the hinge body 32 and the hinge head 40 to rotate or slip slightly within the post 26 and sleeve 24. The resultant “play” or looseness caused by such rotation decreases the effectiveness of the hinge, causes “clicking” sounds when opening and closing the housings 12, 14, and reduces consumer confidence in the device. To reduce or prevent this type of wear and tear on the interior surface of post 26 and sleeve 24, one embodiment of the present disposes first and second retaining boots 50, 52 on the hinge body 32 and the hinge head 40, respectively.

The first and second retaining boots 50, 52 may be formed as sleeves that fit tightly into the openings of post 26 and sleeve 24. The interior and exterior surfaces of the retaining boots 50, 52 may be relatively smooth, low friction surfaces to allow the retaining boots 50, 52 to slide axially over the hinge body 32 and hinge head 40, as well as into the interiors of post 26 and sleeve 24. In some embodiments, the material used to construct one or both of the retaining boots 50, 52 comprises a material that is shrink-fit around the hinge body 32 and hinge head 40. The material used to construct the retaining boots 50, 52 is preferably elastic such that the retaining boots 50, 52 expand after installation. Such expansion effectively allows the retaining boots 50, 52 to “fill-in” any spatial gaps that might develop from the repeated opening and closing of the housings 12, 14. Further, the elasticity of the material prevents cracks or breaks from forming in post 26 and sleeve 24. Some examples of suitable materials include, but are not limited to, DERLIN, NYLON, and other hard plastics or metals.

In some embodiments, each retaining boots 50, 52 is constructed of different materials. By way of example, the materials used to construct the hinge body 32, hinge head 40, and housings 12, 14 may be different. Therefore, each may have a different stiffness or elasticity. When choosing suitable materials for the retaining boots 50, 52, it is preferable to select materials having a stiffness that is less than that of the materials used to construct the hinge head 32, hinge body 40, and housings 12, 14. However, the stiffness of the material should be great enough so that the torque generated from opening and closing the housings 12, 14 does not deform the retaining boots 50, 52. This allows radial compression of the retaining boot material during the axial assembly. The compressed retaining boots 50, 52 will tend to expand to fill in any spatial gaps that might exist between the hinge body 32 and the post 26, and the hinge head 40 and the sleeve 40. Consequently, such pre-compression would also allow the retaining boots 50, 52 to expand during use of the device 10 to maintain the original tight fit between the hinge body 32 and hinge head 40 and the post 26 and sleeve 24.

FIG. 4 illustrates one embodiment showing the cartridge hinge 30 including the retaining boots 50, 52 installed within post 26 and sleeve 24. For clarity, the end cap 60 is not shown. As seen in FIG. 4, the first retaining boot 50 is disposed within post 26, and the second retaining boot 52 is disposed within sleeve 24. Therefore, the first and second retaining boots 50, 52 have generally the same shape as the interior of their corresponding post 26 and sleeve 24. The hinge body 32 and the hinge head 40 are disposed within the interiors of the first and second retaining boots 50, 52, respectively. Thus, the retaining boots 50, 52 lies between the exterior surfaces of the hinge body 32 and hinge head 40, and the interior surfaces of their corresponding post 26 and sleeve 24.

The hinge body 32 and the hinge head 40 fit tightly within their respective retaining boots 50, 52, which in turn, fits tightly within the post 26 and sleeve 24. This tightness prevents the retaining boots 50, 52, the hinge body 32, and the hinge head 40 from rotating within post 26 and sleeve 24 due to the torque generated by the repeated opening and closing the housings 12, 14. During use, the retaining boots 50, 52 expand within post 26 and sleeve 24 to fill-in any spatial gaps between hinge body 32 and the interior of post 26 and the hinge head 40 and the interior of sleeve 24. Because the spatial gaps remain filled, the retaining boots 50, 52 retain the hinge body 32 and the hinge head 40 tightly within the post 26 and sleeve 24. This prevents the hinge body 32 and hinge head 40 from becoming loose within the openings of post 26 and sleeve 24, as well as the “clicking” sounds that are associated with the hinge body 32 and hinge head 40 being loose.

One or both of the retaining boots 50, 52 may also be interchangeable. Particularly, some consumers maintain possession of their electronic devices for extended periods. During this time, the component parts of the cartridge hinge 30 may become worn or broken and need replacement. With conventional devices, replacing a hinge might have required special stations and/or tools to disassemble/re-assemble the device 10. The costs of repair are therefore high relative to the cost of the hinge. The present invention, however, allows the manufacturers to remove a failed cartridge hinge 30 by sliding the hinge body 32 and/or the hinge head 40 from within their respective retaining boots 50, 52. The manufacturer then needs only to replace the hinge within the retaining boot 50. Similarly, manufacturers may replace one or both of the retaining boots 50, 52 and keep the same cartridge hinge 30, or replace both the cartridge hinge 30 and the retaining boots 50, 52 as a unit. In any of these cases, the cost and time required for repair is greatly reduced.

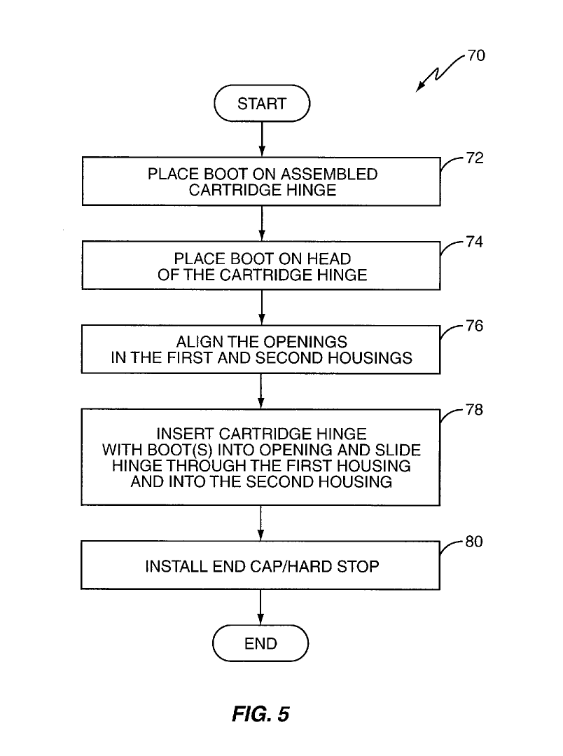

FIG. 5 illustrates a method 70 of installing the cartridge hinge 30 according to one embodiment. It should be noted that FIG. 5 assumes that a cartridge hinge 30 has already been assembled and is available off-the-shelf to the manufacturer. Initially, an installer places the first retaining boot 50 over the hinge body 32 of the cartridge hinge 30 (box 72). The installer then places the second retaining boot 52 over the hinge head 40 (box 74). Once the retaining boots 50, 52 are in place, the installer may align the openings in the sleeve 24 with the opening and the removable bushing in posts 26 to align the housings 12, 14 (box 76). The installer then inserts the cartridge hinge 30, hinge head 40 first, into one of the posts 26 from a side of the housing 14 and slides the cartridge hinge 30 into the opening (box 78).

For the cartridge hinge 30 to slide relatively easily through the opening of post 26 and into sleeve 24, the housings 12, 14 should be opened at a “torque-free” angle α (see FIG. 7). The torque-free angle α is that angle between the housings 12, 14 in the open position where the hinge body 32 and the hinge head 40 do not bias each other. In one embodiment, the torque free angle α is approximately 150°-170°. Upon installation, the hinge head 40 will be disposed within the sleeve 24 and retaining boot 52, and the hinge body 32 will be disposed within the post 26 and the retaining boot 50. The installer may then attach the end cap 60 to the post 26, and a hard stop (not shown) (box 80). The hard stop prevents the device 10 from opening past the point at which the housings 12, 14 form the torque-free angle α. This ensures that the assembled cartridge hinge 30 has a predetermined biasing torque, which tends to urge the housings 12, 14 open or closed.

It should be noted that the installation method 70 may save manufacturers time and cost in assembling cellular telephone 10. Particularly, conventional installation methods require an installer to use a special “jig” tool to compress the hinge head 40 within the hinge body 32 prior to aligning the sleeve 24 with the posts 26. This compresses the spring 42 within the hinge body 32 so that the installer can place the hinge body 32 within the post 26 and align the hinge head 40 with the sleeve 24 opening. When the installer releases the compressive force, the spring 42 decompresses to push the hinge head 40 outwardly into sleeve 24 through the opening.

With the present invention, however, installation is accomplished from the side opening of post 26. That is, the cartridge hinge 30 is pushed axially into the outside opening of post 26 and into sleeve 24. Because the sleeve and the post are already aligned, there is no need for special tools to compress the spring 42. Further, there is no need to compress the hinge head 40 into the hinge body 32 during assembly. Additionally, the cartridge hinge 30 and the retaining boots 50, 52 are pushed into the openings of the sleeve 24 and post 26 with a predetermined axial force, which radially compresses the elastic retaining boots 50, 52. As previously stated, the tendency of the compressed retaining boots 50, 52 to expand creates a tight fit between the cartridge hinge 30 and the interior surfaces of the openings of sleeve 24 and post 26. Further, the retaining boots 50, 52 would expand over time to fill in any unwanted spatial gaps that might develop between the cartridge hinge 30 and the interior surfaces of the openings as the device 10 moves between the open and closed positions. This maintains the tight fit between the cartridge hinge 30 and the interior surfaces of the openings.

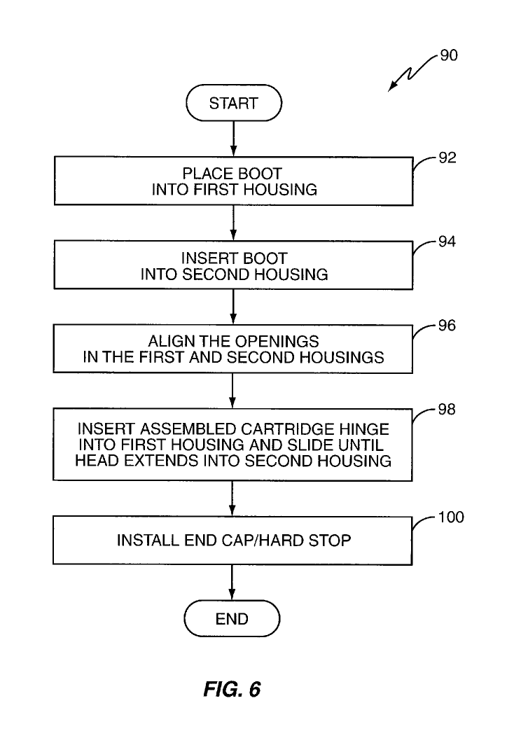

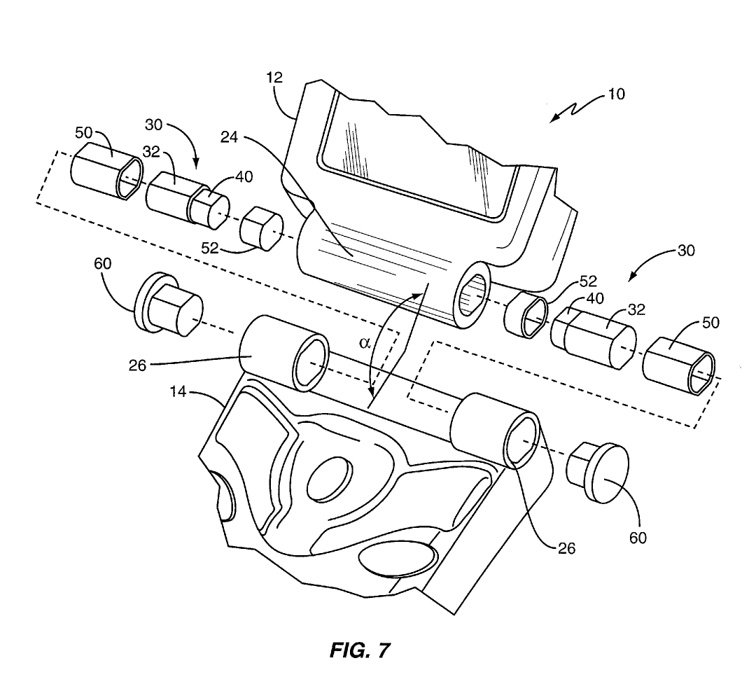

FIG. 6 illustrates a method 80 of installing the cartridge hinge 30 according to another embodiment. As in method 70 of FIG. 7, method 80 assumes that the installer already has an assembled cartridge hinge. Initially, the installer places the retaining boot 50 into the opening of post 26 (box 92). The installer also places the second retaining boot 52 into the opening of sleeve 24 (box 94). Once the retaining boots 50, 52 are in place, the installer aligns the sleeve 24 with the posts 26 (box 96), and inserts the head 40 of the assembled cartridge hinge into one of the posts 26 from a side of the housing 14. The installer then pushes the cartridge hinge 30 through the retaining boot 50 and the post 26 such that the hinge head 40 inserts into the retaining boot 52 in sleeve 24. Once the cartridge hinge 30 is in place, the installer then attaches the end cap 60 and a hard stop as previously described (box 100).

Inserting the hinge body 32 through the retaining boot 50 radially compresses the retaining boot 50. Similarly, inserting the hinge head 40 into the retaining boot 52 radially compresses the retaining boot 52. As previously described, the compressed retaining boots 50, 52 tend to expand to fill in any spatial gaps between the cartridge hinge 30 and the interior surfaces of the openings in sleeve 24 and post 26. This creates and maintains a tight fit between the cartridge hinge 30 and the interior surfaces of the sleeve 24 and post 26.

The present invention may, of course, be carried out in other ways than those specifically set forth herein without departing from essential characteristics of the invention. FIG. 7, for example, illustrates an embodiment wherein a pair of cartridge hinges 30, each including a retaining boot 50, pivotably connect the first and second housings 12, 14. One or both of the cartridge hinges 30 may also include a retaining boot 52 as previously described. Accordingly, the present embodiments are to be considered in all respects as illustrative and not restrictive, and all changes coming within the meaning and equivalency range of the appended claims are intended to be embraced therein.

What is claimed is:

1. A hinge mechanism to pivotably connect the housings of an electronic device, the hinge mechanism comprising:
a hinge body configured to fit into an opening formed in a first housing; and
a first retaining boot disposed within the opening and around the hinge body, and sized to retain the hinge body within the opening.

2. The hinge mechanism of claim 1 wherein the first retaining boot comprises an interchangeable sleeve that substantially surrounds the hinge body.

3. The hinge mechanism of claim 2 wherein the sleeve comprises a material configured to expand within the opening to retain the hinge body within the opening.

4. The hinge mechanism of claim 2 wherein the sleeve comprises an elastic member disposed between an exterior surface of the hinge body and an interior surface of the opening.

5. The hinge mechanism of claim 1 further comprising:
a hinge head coupled to the hinge body; and
a second retaining boot disposed within a corresponding opening in a second housing and around the hinge head, the second retaining boot being sized to retain the hinge head within the corresponding opening.

6. The hinge mechanism of claim 5 wherein the second retaining boot comprises an interchangeable member that substantially surrounds the hinge head.

7. The hinge mechanism of claim 5 wherein the second retaining boot comprises a material configured to expand within the corresponding opening to retain the hinge head within the corresponding opening.

8. The hinge mechanism of claim 5 wherein the second retaining boot comprises an elastic member disposed between an exterior surface of the hinge head and an interior surface of the corresponding opening.

9. The hinge mechanism of claim 1 further comprising an end cap sized to fit within the opening and an end of the first retaining boot.

10. An electronic device comprising:
a first housing pivotally connected to a second housing; and
a hinge mechanism configured to pivotally connect the first and second housings, the hinge mechanism comprising:
a hinge body configured to fit into an opening formed in the first housing; and
a first retaining boot disposed within the opening and around the hinge body, and sized to retain the hinge body within the opening.

11. The electronic device of claim 10 wherein the first retaining boot comprises an interchangeable sleeve that substantially surrounds the hinge body.

12. The electronic device of claim 11 wherein the sleeve comprises an elastic member configured to expand within the opening to retain the hinge body within the opening.

13. The electronic device of claim 10 further comprising:
a hinge head coupled to the hinge body; and
a second retaining boot disposed within a corresponding opening in the second housing and around the hinge head, the second retaining boot being sized to retain the hinge head within the corresponding opening.

14. The electronic device of claim 13 wherein the second retaining boot comprises an interchangeable member that substantially surrounds the hinge head.

15. The electronic device of claim 14 wherein the interchangeable member comprises an elastic member configured to expand within the corresponding opening to retain the hinge head within the corresponding opening.

16. The electronic device of claim 11 further comprising a second hinge mechanism configured to pivotally connect the first and second housings, the second hinge mechanism comprising:
a hinge body configured to fit into a second opening formed in the first housing; and
a retaining boot disposed within the second opening and around the hinge body of the second hinge mechanism, and sized to retain the hinge body of the second hinge mechanism within the second opening.

17. The electronic device of claim 10 wherein the hinge mechanism comprises a cartridge hinge.

18. A method of pivotably connecting first and second housings of an electronics device, the method comprising:
aligning an opening formed in a first housing of an electronic device with a corresponding opening formed in a second housing of the electronic device;
inserting a hinge body into the aligned openings such that a first retaining boot is disposed between an exterior surface of the hinge body and an interior surface of the opening, the first retaining boot being sized to retain the hinge body within the opening.

19. The method of claim 18 wherein aligning the opening formed in the first housing with the corresponding opening formed in the second housing comprises aligning a sleeve integrally formed on the second housing between a pair of posts integrally formed on the first housing.

20. The method of claim 18 wherein the first retaining boot comprises an elastic sleeve, and wherein inserting a hinge body into the aligned openings comprises:
inserting the elastic sleeve into the opening; and
inserting the hinge body into the elastic sleeve disposed in the opening.

21. The method of claim 20 wherein the hinge body comprises a hinge head, and wherein the method further comprises:
inserting a second retaining boot into the corresponding opening; and
inserting the hinge head into the corresponding opening.

22. The method of claim 18 wherein the first retaining boot comprises an elastic sleeve, and wherein inserting a hinge body into the aligned openings comprises inserting the hinge body into the elastic sleeve.

23. The method of claim 22 further comprising inserting the hinge body having the elastic sleeve disposed around an exterior surface of the hinge body into the opening.

24. The method of claim 22 wherein the hinge body connects to a hinge head, and wherein the method further comprises:
inserting the hinge head into a second retaining boot; and
inserting the hinge body having the first retaining boot thereon, and the hinge head having the second retaining boot thereon, into the openings such that the first retaining boot is disposed between an exterior surface of the hinge body and an interior surface of the opening, and the second retaining boot is disposed between an exterior surface of the hinge head and an interior surface of the corresponding opening.
